(19) United States
(12) Patent Application Publication
(10) Pub. No.: US 2024/0210690 A1
(43) Pub. Date: Jun. 27, 2024

(54) VEHICLE DISPLAY DEVICE

(71) Applicant: YAZAKI CORPORATION, Tokyo (JP)

(72) Inventor: Noriaki Narushima, Susono-shi (JP)

(21) Appl. No.: 18/599,225

(22) Filed: Mar. 8, 2024

Related U.S. Application Data
(63) Continuation of application No. PCT/JP2022/047655, filed on Dec. 23, 2022.

(30) Foreign Application Priority Data
Jan. 12, 2022 (JP) 2022-002804

(51) Int. Cl. G02B 27/01

(52) U.S. Cl. CPC G02B 27/0101

(57) ABSTRACT

A vehicle display device includes: a housing having an opening facing a windshield; an image display device; a mirror that reflects display light towards the windshield; and a cover that transmits the display light, the cover being transparent and disposed in the opening, in which the cover has an outer surface facing the windshield and an inner surface facing the mirror and is curved towards the inside of the housing, the inner surface is a freeform surface formed to correct distortion or aberration of an image, and the shape of the inner surface sets a separation angle of colors due to chromatic aberration to less than or equal to 1 [mrad] in the display light transmitted through the cover and emitted towards the windshield.

### CROSS-REFERENCE TO RELATED APPLICATION(S)

This application is a continuation application of International Application PCT/JP2022/047655, filed on Dec. 23, 2022 which claims the benefit of priority from Japanese Patent Application No. 2022-002804 filed on Jan. 12, 2022 and designating the U.S., the entire contents of which are incorporated herein by reference.

### BACKGROUND OF THE INVENTION

### 1. Field of the Invention

The present invention relates to a vehicle display device.

### 2. Description of the Related Art

Conventionally, there are vehicle display devices such as head-up displays. Japanese Patent Application Laid-open No. 2008-268883 discloses a head-up display device that causes an occupant of a vehicle to visually recognize a virtual image of image light with the image light, transmitted through a cylindrical lens, reflected by a front windshield. In Japanese Patent Application Laid-open No. 2008-268883, chromatic aberration is corrected using a plurality of lenses made of materials having different refractive indexes and chromatic dispersions.

In a vehicle display device, it is desirable that chromatic aberration can be suppressed with a simple configuration. For example, it is preferable that both suppression of an increase in the number of types of material or the number of parts and suppression of chromatic aberration can be achieved.

### SUMMARY OF THE INVENTION

An object of the present invention is to provide a vehicle display device capable of suppressing chromatic aberration with a simple configuration.

A vehicle display device according to one aspect of the present invention includes a housing mounted on a vehicle, the housing having an opening facing a windshield; an image display device that outputs display light of an image, the image display device disposed inside the housing; a mirror that reflects the display light towards the windshield, the mirror disposed inside the housing and facing the windshield via the opening; and a cover that transmits the display light, the cover being transparent and disposed in the opening, wherein the cover has an outer surface facing the windshield and an inner surface facing the mirror and is curved towards an inside of the housing, the inner surface is a freeform surface formed to correct distortion or aberration of the image, and a shape of the inner surface sets a separation angle of colors due to chromatic aberration to less than or equal to 1 [mrad] in the display light transmitted through the cover and emitted towards the windshield.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a vehicle on which a vehicle display device according to an embodiment is mounted;

FIG. 2 is a perspective view of the vehicle display device of the embodiment;

FIG. 3 is a perspective view illustrating display light transmitted through a cover of the embodiment; and

FIG. 4 is a cross-sectional view illustrating display light transmitted through the cover of the embodiment.

### DETAILED DESCRIPTION OF THE PREFERRED EMBODIMENTS

Hereinafter, a vehicle display device according to an embodiment of the present invention will be described in detail with reference to the drawings. Note that the invention is not limited by the embodiments. In addition, components in the following embodiment include those that can be easily conceived by those skilled in the art or those that are substantially the same.

### Embodiments

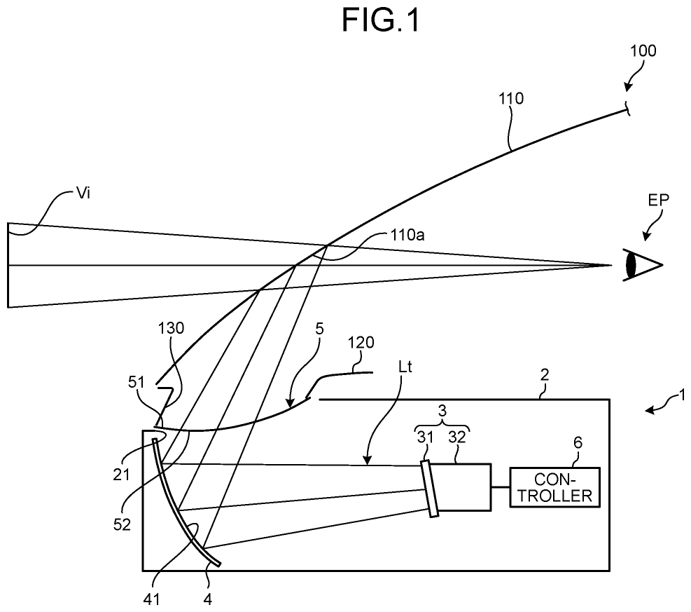

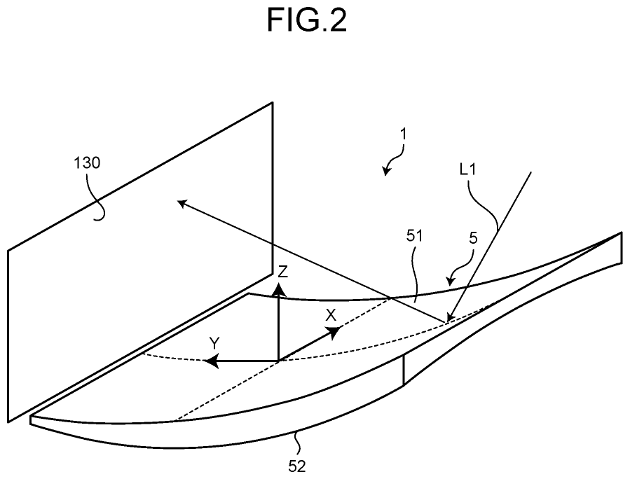

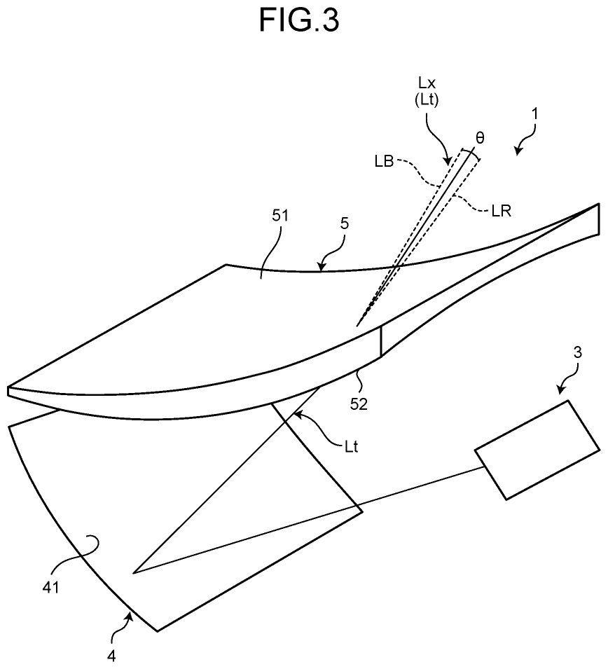

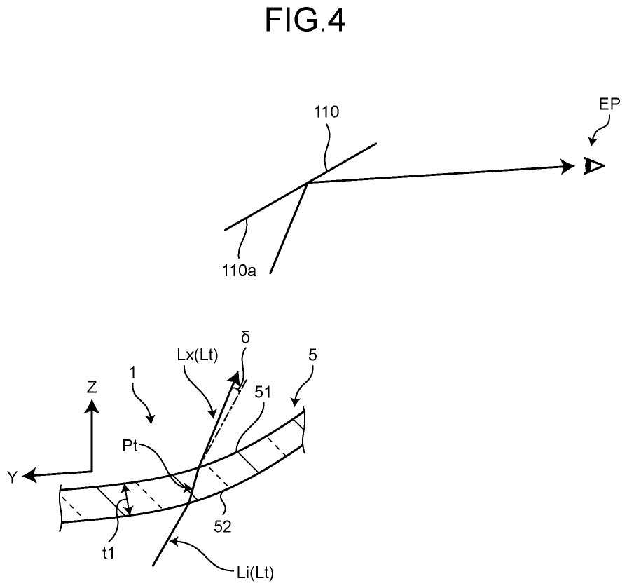

Embodiments will be described with reference to FIGS. 1 to 4. The present embodiment relates to a vehicle display device. FIG. 1 is a diagram illustrating a vehicle on which the vehicle display device according to the embodiment is mounted, FIG. 2 is a perspective view of the vehicle display device of the embodiment, FIG. 3 is a perspective view illustrating display light transmitted through a cover of the embodiment, and FIG. 4 is a cross-sectional view illustrating display light transmitted through the cover of the embodiment.

As illustrated in FIG. 1, a vehicle display device 1 according to the present embodiment is a head-up display device mounted on a vehicle 100 such as an automobile. The vehicle display device 1 projects display light Lt of an image towards a windshield 110. The display light Lt is reflected by a reflecting surface 110a of the windshield 110 towards an eye point EP. A driver of the vehicle 100 can visually recognize a virtual image Vi by the display light Lt. The virtual image Vi may be displayed to be superimposed on an object ahead of the vehicle 100. The virtual image Vi may be a meter image of the vehicle 100.

The vehicle display device 1 includes a housing 2, an image display device 3, a mirror 4, a cover 5, and a controller 6. The housing 2 is disposed on the front side of the vehicle with respect to the eye point EP and is accommodated in, for example, an instrument panel 120. The housing 2 is formed of a light-shielding material. The housing 2 has an opening 21 facing the windshield 110 in the up-down direction of the vehicle. The illustrated opening 21 is disposed on the top face of the housing 2 and is positioned at the front end of the housing 2.

The image display device 3 and the mirror 4 are arranged inside the housing 2. The image display device 3 outputs display light Lt of an image. The illustrated image display device 3 includes a display 31 and a backlight unit 32. The display 31 is, for example, a liquid crystal display device such as a thin film transistor-liquid crystal display (TFT-LCD). The image display device 3 generates the display light Lt by light of the backlight unit 32. The display 31 and the backlight unit 32 are controlled by the controller 6.

The mirror 4 is a reflecting member that reflects the display light Lt towards the windshield 110. The mirror 4 has a concave reflecting surface 41 and is capable of enlarging an image. The reflecting surface 41 of the mirror 4 is, for example, a freeform surface having an image correction function. More specifically, the shape of the reflecting surface 41 is designed to correct image distortion that occurs when the display light Lt is reflected by the reflecting surface 110a of the windshield 110. The display light Lt reflected by the reflecting surface 41 is further reflected by the windshield 110 towards the eye point EP.

The cover 5 is disposed in the opening 21 of the housing 2 and closes the opening 21. The cover 5 is a transparent member and is molded using, for example, transparent resin. The shape of the cover 5 is curved towards the inside of the housing 2. The curved shape of the cover 5 is defined so as to reflect external light towards a facing 130. The facing 130 is a light shielding wall provided to the instrument panel 120. The facing 130 has a low reflectance and can absorb external light. The surface shape of the facing 130 may diffuse light. The facing 130 is disposed on the front side of the vehicle with respect to the cover 5 and extends along the up-down direction of the vehicle.

The cover 5 has an outer surface 51 and an inner surface 52. The outer surface 51 faces upward in the vehicle and faces the windshield 110. The inner surface 52 faces downward in the vehicle and faces the mirror 4.

FIG. 2 is a perspective view of the cover 5. The cover 5 has a first direction X, a second direction Y, and a third direction Z. The first direction X corresponding to the lateral direction of the virtual image Vi, and the second direction Y corresponds to the vertical direction of the virtual image Vi. The third direction Z is the up-down direction of the vehicle. The third direction Z is, for example, orthogonal to the first direction X. The shape of the outer surface 51 on a YZ plane is a curved shape, for example, an arc shape. The outer surface 51 is curved downward in the up-down direction of the vehicle. The shape of the outer surface 51 on an XZ plane is, for example, a linear shape.

The outer surface 51 is formed to reflect external light L1 towards the facing 130. For example, the outer surface 51 can reflect the external light L1, which is transmitted through the windshield 110 and incident on the outer surface 51, towards the facing 130. The facing 130 can suppress the external light reflected by the cover 5 from traveling towards the eye point EP, thereby enabling to improve the visibility of the virtual image Vi.

The shape of the inner surface 52 is a freeform surface. For example, the shape of the inner surface 52 on a YZ plane and the shape of the inner surface 52 on an XZ plane are freeform curves. The shape of the inner surface 52 is defined to correct distortion or aberration of an image. The inner surface 52 is designed to correct, for example, at least one of distortion occurring on the reflecting surface 41 of the mirror 4 or distortion occurring on the reflecting surface 110a of the windshield 110. The inner surface 52 is designed to correct, for example, at least one of aberration occurring on the reflecting surface 41 or aberration occurring on the reflecting surface 110a. The inner surface 52 may correct both image distortion and aberration and may correct either image distortion or aberration.

The cover 5 transmits the display light Lt traveling from the mirror 4 to the windshield 110. As described below, the cover 5 of the present embodiment is structured in such a manner that a color separation angle due to chromatic aberration is less than or equal to 1 [mrad]. In FIG. 3, the display light Lt transmitted through the cover 5 is illustrated.

The display light Lt reflected by the mirror 4 enters the cover 5 from the inner surface 52, passes through the inside of the cover 5, and is emitted from the outer surface 51. Emitted light Lx includes red light LR and blue light LB. The cover 5 is structured to set a separation angle θ of colors due to chromatic aberration to less than or equal to 1 [mrad] in the emitted light Lx.

The separation angle θ is a color separation angle in visible light and is, for example, an angle formed by the red light LR and the blue light LB.

In a case where the display 31 has color filters, the red light LR may be light generated by a red filter, and the blue light LB may be light generated by a blue filter. In a case where the image display device 3 is an organic EL display, the red light LR may be light output from a red EL element, and the blue light LB may be light output from a blue EL element. In a case where the image display device 3 generates an image by laser light, the red light LR may be light output from a red laser element, and the blue light LB may be light output from a blue laser element.

In the cover 5 of the present embodiment, for example, the shape of the inner surface 52 is designed in relation to the outer surface 51 designed to be capable of reflecting the external light L1 to the facing 130. The condition of the optical design for the inner surface 52 includes both a condition for correcting distortion or aberration of an image and a condition for setting the separation angle θ to less than or equal to 1 [mrad]. That is, the inner surface 52 is imparted with a correction function to an extent that the separation angle θ does not exceed 1 [mrad].

As illustrated in FIG. 4, the cover 5 has a predetermined optical path Pt. The predetermined optical path Pt is an optical path of the display light Lt traveling towards the eye point EP. The display light Lt transmitted through the cover 5 along the predetermined optical path Pt is reflected by the reflecting surface 110a of the windshield 110 towards the eye point EP. The cover 5 has a predetermined optical path Pt corresponding to each point on the inner surface 52.

The cover 5 is structured in such a manner that the separation angle θ of the display light Lt emitted towards the windshield 110 through the predetermined optical path Pt is set to less than or equal to 1 [mrad]. Since the separation angle θ of the display light Lt towards the eye point EP becomes sufficiently small, blurring of the image and the like are suppressed. Therefore, the vehicle display device 1 according to the present embodiment can improve the image quality of the virtual image Vi.

In the optical design of the cover 5, the shape of the inner surface 52 is designed on the basis of, for example, a thickness t1 of the cover 5, the refractive index of the material of the cover 5, the Abbe number of the material of the cover 5, and others. The cover 5 may be designed in such a manner that an angular difference 67 between the incident light Li and the emitted light Lx is equal to or less than an upper limit angle. Note that the incident light Li is the display light Lt incident on the inner surface 52. The emitted light Lx is the display light Lt corresponding to the incident light Li and is the display light Lt transmitted through the cover 5 along the predetermined optical path Pt and emitted from the outer surface 51. The angular difference δ between the incident light Li and the emitted light Lx is, for example, an angle on the YZ plane. By reducing the angular difference δ, the separation angle θ can be reduced.

In a case where the cover 5 has a large Abbe number, chromatic aberration in the cover 5 is suppressed. Therefore, in a case where the cover 5 is molded using a material having a large Abbe number, the degree of freedom in design with respect to the inner surface 52 increases. For example, in a case where the Abbe number of the cover 5 is large, the upper limit angle of the angular difference δ may be increased.

In the vehicle display device 1 of the present embodiment, an image enlarging action is implemented mainly by the mirror 4. The shape of the cover 5 is determined for correction of aberration such as distortion. Therefore, it is easy to reduce the angular difference δ between the incident light Li and the emitted light Lx as compared with a case where an image is enlarged by the cover 5.

As described above, the vehicle display device 1 according to the present embodiment includes the housing 2, the image display device 3, the mirror 4, and the cover 5. The housing 2 is mounted on the vehicle 100 and has the opening 21 facing the windshield 110. The image display device 3 is disposed inside the housing 2 and outputs the display light Lt of an image. The mirror 4 is disposed inside the housing 2 and faces the windshield 110 via the opening 21. The mirror 4 reflects the display light Lt towards the windshield 110. The cover 5 is a transparent member that is disposed in the opening 21 and transmits the display light Lt.

The cover 5 has the outer surface 51 facing the windshield 110 and the inner surface facing the mirror 4. The cover 5 is curved towards the inside of the housing 2. The inner surface 52 is a freeform surface formed to correct distortion or aberration of an image. The shape of the inner surface 52 sets the separation angle θ of colors due to chromatic aberration less than or equal to 1 [mrad] in the display light Lt transmitted through the cover 5 and emitted towards the windshield 110. The vehicle display device 1 of the present embodiment can suppress color separation in the display light Lt and improve the image quality of the virtual image Vi.

The vehicle display device 1 of the present embodiment can suppress chromatic aberration by the shape and the material of the cover 5 and improve the image quality of the virtual image Vi. As a comparative example, a configuration for correcting chromatic aberration by combining a plurality of lenses will be examined. In the comparative example, use of the plurality of lenses leads to an increase in manufacturing cost. The vehicle display device 1 of the present embodiment can reduce chromatic aberration with suppressed manufacturing cost. In addition, in the configuration of the present embodiment, the thickness of the cover 5 can be reduced, and variations in the thickness can also be reduced. Therefore, the time required for manufacturing the cover 5 can be shortened, and the amount of material to be used can also be reduced.

According to the present embodiment, since the inner surface 52 performs aberration correction, the magnification of the mirror 4 can be increased as compared with a case where the inner surface 52 does not have the aberration correction function. By increasing the magnification of the reflecting surface 41 of the mirror 4, the vehicle display device 1 can be downsized.

The cover 5 of the present embodiment has a predetermined optical path Pt which is an optical path of the display light Lt traveling towards the eye point EP of the vehicle 100. The cover 5 sets the separation angle θ of the display light Lt emitted towards the windshield 110 through the predetermined optical path Pt to less than or equal to 1 [mrad]. Therefore, the cover 5 of the present embodiment can suppress color separation in the display light Lt traveling towards the eye point EP and improve the image quality of the virtual image Vi.

Note that the shape of the cover 5 is desirably designed in such a manner that the separation angle θ is less than or equal to 1 [mrad] at each point inside an eyellipse or inside an eye box.

The content disclosed in the above embodiment can be implemented in combination as appropriate.

In a vehicle display device according to the embodiment, an inner surface of a transparent cover is a freeform surface formed to correct distortion or aberration of an image. The shape of the inner surface sets a color separation angle due to chromatic aberration less than or equal to 1 [mrad] in display light transmitted through the cover and emitted towards a windshield. According to the vehicle display device of the present invention, it is possible to suppress chromatic aberration of display light with a simple configuration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
a housing mounted on a vehicle, the housing having an opening facing a windshield;
an image display device that outputs display light of an image, the image display device disposed inside the housing;
a mirror that reflects the display light towards the windshield, the mirror disposed inside the housing and facing the windshield via the opening; and
a cover that transmits the display light, the cover being transparent and disposed in the opening, wherein
the cover has an outer surface facing the windshield and an inner surface facing the mirror and is curved towards an inside of the housing,
the inner surface is a freeform surface formed to correct distortion or aberration of the image, and
a shape of the inner surface sets a separation angle of colors due to chromatic aberration to less than or equal to 1 [mrad] in the display light transmitted through the cover and emitted towards the windshield.

2. The vehicle display device according to claim 1, wherein
the cover has a predetermined optical path, the predetermined optical path being an optical path of the display light traveling towards an eye point of the vehicle, and
the cover sets the separation angle in the display light emitted towards the windshield through the predetermined optical path to less than or equal to 1 [mrad].
